(19) United States
(12) Patent Application Publication
(10) Pub. No.: US 2019/0137719 A1
(43) Pub. Date: May 9, 2019

(54) ADJUSTABLE ROUND CABLE SLITTER

(71) Applicant: Uraseal, Inc., Dover, NH (US)

(72) Inventors: William H. Mann, Boston, MA (US); Jeffrey J. DeGrechie, Rochester, NH (US); Brian D. Nelson, Stratham, NH (US)

(21) Appl. No.: 16/130,424

(22) Filed: Sep. 13, 2018

Related U.S. Application Data
(60) Provisional application No. 62/558,008, filed on Sep. 13, 2017.

(51) Int. Cl. G02B 6/44; B26B 5/00

(52) U.S. Cl. CPC G02B 6/4497; B26B 5/00

(57) ABSTRACT

An adjustable cable slitter includes two components each comprising a main body portion, a coupling device at one end of the main body portion and a T-shaped handle disposed at an opposite end of the main body portion. The coupling device couples the two components together allowing the two components to rotate and be expanded. A channel runs along an interior length of each of the main body portions. A blade housing on at least one of the components of the main body portion securely holds a knife blade with a predetermined amount of cutting edge protruding into the channel. The knife blade tip can be oriented to cut a circumferential cut in the cable sheath or a longitudinal cut along the length of the cable. The exposed portion of the blade pierces the sheath cutting the cable near its end or in a middle of the cable.

### CROSS-REFERENCE TO RELATED APPLICATIONS

This application claims priority from U.S. Provisional Patent Application No. 62/558,008, titled “ADJUSTABLE ROUND ADJUSTABLE CABLE SLITTER”, which was filed on Sep. 13, 2017 and is incorporated fully herein by reference.

### TECHNICAL FIELD

The present invention relates to adjustable cable slitters and more particularly, relates to a two-piece adjustable cable slitter designed to score the exterior layer or sheathing of a round cable.

### BACKGROUND INFORMATION

The jacket or covering of cables, such as, but not limited to, fiber optic cables, often need to be slit and removed from either the middle or the end of the cables during installation or repair. To accomplish this, a technician generally cuts through the cable jacket using an open faced knife or a makeshift adjustable cable slitter. This activity, however, can be difficult to accomplish, exposes the technician to potential injury from the open faced knife or makeshift adjustable cable slitter due to knife or slitter slipping, and generally requires an individual with the requisite skill and strength particularly when the cable jacket is made of a hard or cut resistant material and a long length from the cable jacket must be removed. In addition, the process can cut too deeply into the cable (deeper than simply cutting through the cable jacket or sheath), causing damage to the core of the cable. In the case of fiber optic cables, the optical fiber itself can be damaged by cutting or excessive cable twisting.

With the proliferation of various communications cables, such as fiber-optic cables, there are differences in the number of actual transmission cables located within the cable jacket or covering and thus, the exterior or outside dimension of the cables can vary extensively dependent upon how many individual fibers or cables are located inside the sheathing. Accordingly, many of the prior art cable sheath cutters are sized for only one size of cable. Multiple cutters are needed for multiple cable sizes. This presents a problem to the technicians in that they now must carry multiple cutters in their service vehicle or even worse, carry multiple cutters into the field.

In addition to different sized cables, cable installers and technicians are also faced with the fact that in some instances, they need to “slit” the cable mid-span in order to splice the cable while in other instances, they desire to open or strip the cable jacket proximate an end of the cable thus requiring a round or circular cut around the circumference of the cable jacket or sheath. Again, this requires multiple prior art cutters as one cutter may be configured to slit the cable mid-span while another is configured for a circumferential/circular cut in the cable jacket.

Accordingly, what is needed is a universal round cable jacket cutter that allows a user to easily, safely and precisely cut the exterior jacket or sheathing of a cable of varying diameter either at an end of a cable or at any point along the length of a cable.

### SUMMARY

The present invention relates to a device for cutting an exterior layer (the cable jacket or sheath) of a cable, the device comprising a first component and a second component, each of the first and second components having a main body portion having a length, an exterior side, an interior side, a first end and a second end opposite the first end. Each of the first and second components include a channel that runs along the entire length of the interior side of the first and second components.

The first end of the main body portion of each of the first and second components has a T-shaped handle and the second end of the main body portion of the first component is designed to releasably, rotatably and expandably interconnect with the second end of the main body portion of the second component. The second end of the main body portion of the first component is designed to interconnect with the second end of the main body portion of the second component in such a manner (expandably) that the spacing between an interior side or surface of the first component and the interior side or surface of the second component can be adjusted to accommodate for round cables of differing sizes/thicknesses. The first and second rotatably interconnected components are configured for receiving a cable in the channel in the interior side of the first and second components.

The invention also includes at least one blade housing, located on the exterior side of at least one of the first and second components within the main body portion, the at least one blade housing configured for securely and removably holding at least one knife blade (preferably in the shape of a blade having an arrow shape with a double sided cutting surface) in a position such that at least a portion of the at least one knife blade protrudes into a cable channel in the interior side of the at least one of the first and second components and at least partially into the channel of the at least one of the first and second components on which the knife blade is located. The at least one knife blade can be turned or rotated at least 90° allowing the device to be used in one mode wherein the blade is oriented to cut the cable jacket or sheath circumferentially allowing the user to strip the cable jacket proximate the end of a cable or alternatively, in a second mode wherein the blade is oriented to cut the cable jacket or sheath along the length of the cable allowing the user to strip the cable jacket in a central region of the cable to splice or fix broken cable.

A further aspect of the device allows the first and second components to be configured for being expanded or spaced apart further to allow for larger to smaller diameter cables and also disconnected from one another.

In order to splice the exterior layer or jacket of the cable, the cable is inserted into the cable channel of the device and the first and second components are configured for being rotatably connected and brought into a closed, confronting position whereby the interior portion of the first component contacts or faces the interior portion of the second component. The device is further configured to cut the exterior layer of the cable when the first and second components in the closed position are, in one mode advanced along a length of the cable (central region cable jacket cutting) with the knife bald in the proper orientation, and in a second mode the device can be rotated or turned 360° around the cable to cut the jacket of the cable generally proximate the end of the cable.

In a preferred embodiment of the present invention, the first and second components of the device are nearly identical in shape and dimension with the exception of the second end of the first and second components. The second end of one of the first or second components includes a slotted opening disposed in a flange wherein the flange includes arcuate shaped grooves, while the second end of the other of the first or second components includes a circular protrusion having one or more exterior elements designed to interconnect with the arcuate grooves in the flange of the other of the first or second component. The first and second components may be made from a plastic material. The plastic material is preferably a “slippery” plastic material such as PTFE allowing the cable to easily “slide” within the channel on the interior side of the first and second components.

An additional aspect of the present invention is the formation of a path by the channel of the first component and the channel of the second component when the first and second components are brought into a closed, confronting position against one another. The path or channel that is formed has a generally circular or round shape designed to accept a circular or round fiber-optic cable.

In a further embodiment of the present invention, the at least one blade housing includes a first blade housing located on the exterior side of the first component and a second blade housing located on the exterior side of the second component.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is perspective open, top view of the adjustable cable slitter according to a first embodiment of the present invention;

FIG. 2 is a perspective top view of the adjustable cable slitter according to the first embodiment of the present invention in an opened position showing the first and second members detached from one another;

FIG. 3 is a close-up of the a first end of one member of the adjustable cable slitter according to the first embodiment of the present invention;

FIG. 4 is a close-up view of the first end of a second member of the adjustable cable slitter according to the first embodiment of the present invention;

FIG. 5 is a side view of the adjustable cable slitter of the first embodiment of the present invention showing the knife or cutter mounting element to be mounted on one of the first or second members;

FIG. 6 is a side view of the adjustable cable slitter of the first embodiment of the present invention as shown in FIG. 5 wherein the knife or cutter mounting element is mounted on the first or second element;

FIG. 6A illustrates and exploded view of the knife or cutter and knife cutter element to be mounted into the first or second member showing the underside of the elements in accordance with the first embodiment of the invention;

FIG. 6B is an exploded view of the knife and knife mounting element according to the first embodiment of the invention;

FIG. 6C is a phantom view of the knife cutter holding element showing the knife holder protrusion engaged with the first pair of ribs on the first member according to the first embodiment of the invention;

FIGS. 6D and 6E are underside views of the first and second members showing the cable channel and knife tip protruding into the cable channel according to the first embodiment of the invention;

FIG. 7 is a side view of the adjustable cable slitter of the present invention illustrating how the knife or cutter is inserted into the knife or cutter mounting element according to the first embodiment of the invention;

FIG. 8 is a side plan view of the adjustable cable slitter of the present invention wherein the knife or cutter mechanism is mounted into the knife or cutter mounting element according to the first embodiment of the invention;

FIGS. 9 and 10 are exploded perspective views of the knife or cutter according to one feature of each of the embodiments of the present invention;

FIG. 11 is a perspective view of the assembled knife or cutter according to the first embodiment of the invention;

FIG. 12 is a perspective exploded view of the adjustable cable slitter of the present invention illustrating one of two “T” handle members along with the knife or cutter mounting element and an exploded view of the knife or cutter according to the first embodiment of the invention;

FIG. 13 is a top perspective view of a second embodiment of the adjustable round cable slitter of the present invention;

FIG. 14 is a bottom perspective view of the second embodiment of the adjustable round cable slitter of the present invention;

FIG. 15 is an inside view of the top portion of the two-piece adjustable cable slitter according to the second embodiment of the present invention;

FIG. 16 is a top view of the top portion of the two-piece adjustable cable slitter according to the second embodiment of the present invention;

FIG. 17 is a top view of the top portion of the two-piece adjustable cable slitter with the knife blade mounting element removed according to the second embodiment of the present invention;

FIG. 18 is a bottom view of the bottom portion of the two-piece adjustable cable slitter according to the second embodiment of the present invention;

FIG. 19 is an inside view of the bottom portion of the two-piece adjustable cable slitter according to the second embodiment of the present invention;

FIG. 20 is an inside perspective view of a first half of the blade holder according to the second embodiment of the present invention;

FIG. 21 is an outside perspective view of the one half of the blade holder of FIG. 20 according to the second embodiment of the present invention;

FIG. 22 is a perspective view of the threaded protrusion provided on the blade holder according to the second embodiment of the present invention;

FIG. 23 is an inside perspective view of a second half of the blade holder according to the second embodiment of the present invention;

FIG. 24 is a top perspective view of the first portion of the two-piece adjustable cable slitter according to the second embodiment of the present invention illustrating a threaded opening for receiving a blade holder;

FIG. 25 is a cross-sectional view of the top portion of the two-piece adjustable cable slitter according to the second embodiment of the present invention illustrating the blade mounted captive and the blade holder assembly which has been threaded into the top portion;

FIG. 26 is a front perspective view of the spring cap according to one feature of the second embodiment of the present invention;

FIG. 27 is a rear perspective view of the spring cap according to one feature of the second embodiment of the present invention;

FIG. 28 is a perspective view of the assembled two-piece adjustable cable slitter according to the second embodiment of the present invention illustrating the spring cap and pressure plate retaining member in place;

FIG. 29 is a cross-sectional view of the assembled two-piece adjustable cable slitter according to the second embodiment of the present invention illustrating the knife blade tip and pressure plate located in the channel of the assembled device;

FIG. 30 is a rear perspective view of the pressure plate according to one feature of the second embodiment of the present invention; and

FIG. 31 is a front perspective view of the pressure plate of FIG. 30 according to one feature of the second embodiment of the present invention.

### DETAILED DESCRIPTION OF THE PREFERRED EMBODIMENTS

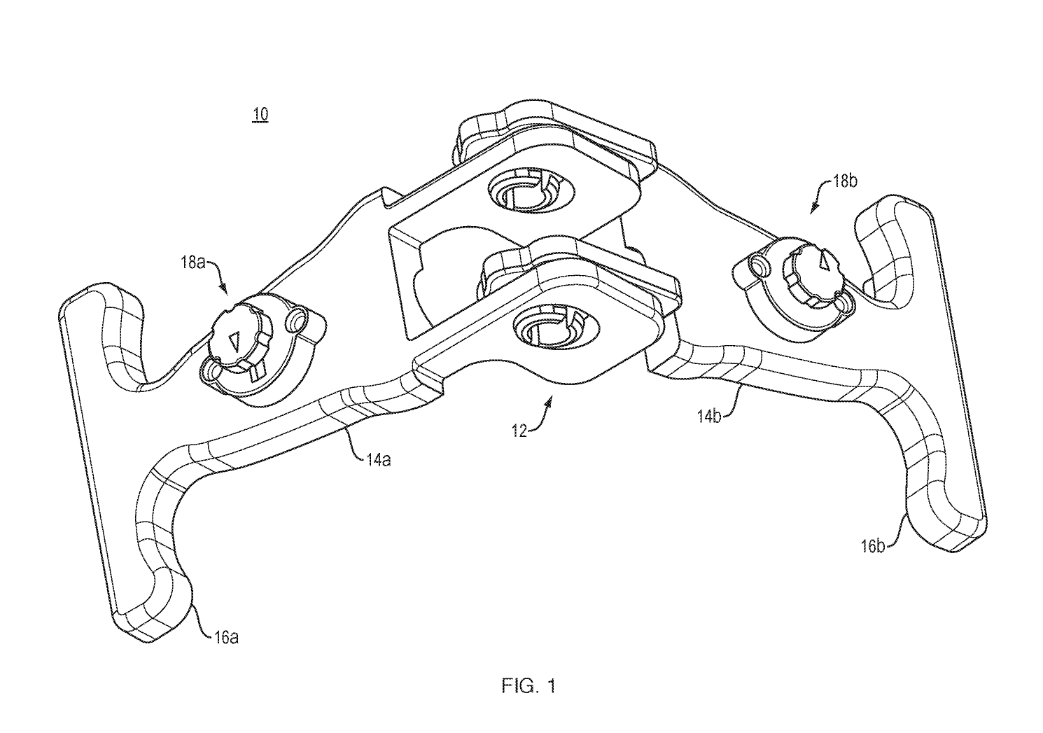

The adjustable cable slitter 10, FIG. 1, in accordance with a first embodiment of the present invention, includes a hinge portion 12 a body portion 14 and a T-shaped handle portion 16. The adjustable cable slitter 10 is preferably made from a relatively strong, weatherproof, durable material such as plastic, aluminum or composite material. The plastic material is preferably a smooth, high slip material that is self-lubricating, such as an acetyl polymer, which may be purchased from Celanese Corporation, or another suitable plastic material. This type of generally “slippery” plastic material facilitates sliding the adjustable cable slitter along the length of a cable to be slit.

The T-shaped handle portion 16 is arranged perpendicular to the body portion 14. The body portion 14 further includes one or more blade housings 18 that hold and enclose a blade. The blade can be a knife blade, a utility knife blade, a mini blade, or any other suitable blade. The blade is used to penetrate the cable jacket or sheath (not shown) without cutting the underlying cable wires or filaments. The penetration can be in the form of a cut or slice, or any other means which provides access to the interior region of the cable and the one or more cable wires or filaments contained within the cable jacket or sheath.

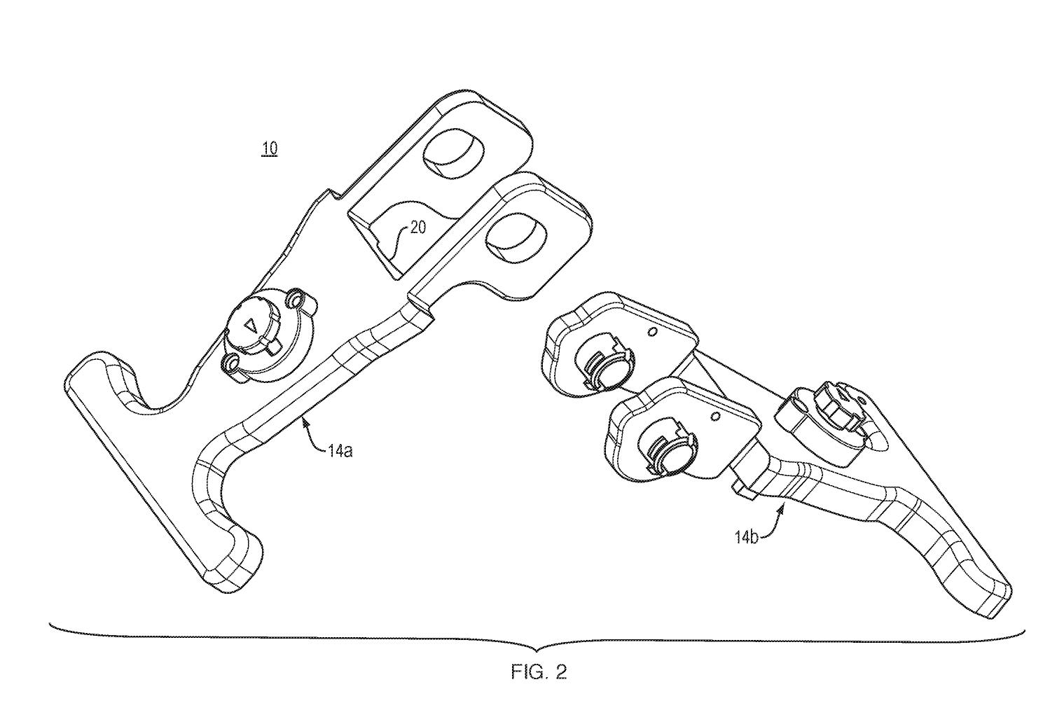

The hinge portion 12 allows the body portion 14 to come apart into two pieces (see FIG. 2) allowing, in one embodiment, the adjustable cable slitter 10 to be placed at any point along a given length of cable to allow the cable jacket or sheath to be slit and a splice or other interconnection made along the middle of the cable. Alternatively, the adjustable cable slitter 10 may be inserted over the end of the cable without disconnecting or disengaging the two body portions 14.

The adjustable cable slitter 10, FIG. 2, includes a first component 14A and a second component 14B. The first and second components each include a groove or channel 20 into which the cable will fit. The first and second components 14 typically contain one channel. The cable can be a fiber optic cable, a copper cable, or any other type of cable.

The hinge portion 12, FIG. 2, is constructed and arranged such that the first component 14a is separable from the second component 14b allowing the adjustable cable slitter 10 to be placed over and around the cable at any point along the cable. The first component and the second component can rotate from an open position (shown in FIG. 2) to a closed position (shown in Figure X (Bill: we should show closed position if possible). In a closed position, the protrusions 22 on the T-shaped handle 16 of the first component, if provided, will insert into the corresponding holes 24, if provided, of the second component and vice versa.

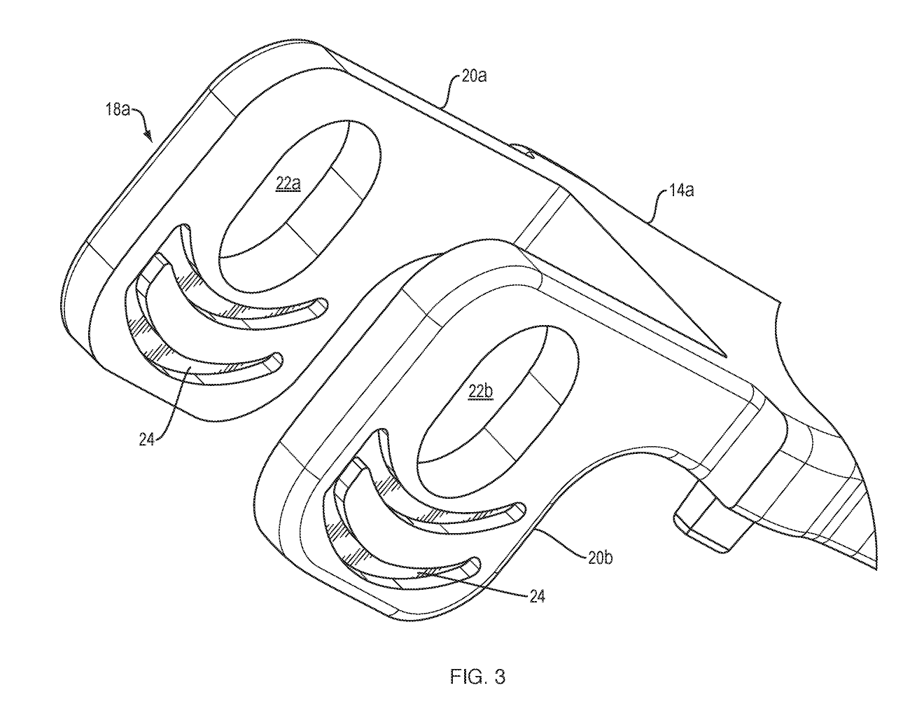

FIG. 3 illustrates the adjustable end 18a of the first component 14a. The adjustable end 18a includes first and second parallel flanges 20 each of which include and oval shaped opening 22 as well as a plurality of arcuately shaped grooves or slots 24 which are designed to mate with protrusions from the 2^{nd} component 14b as will be illustrated below to allow the adjustable cable slitter 10 to be adjustable to accommodate cables of various size and thickness.

FIG. 4 illustrates the adjustable end 18b of the second component 14b. The adjustable and 18b includes first and second parallel flanges 24 each of which includes a circular shaped protrusion 26 on which are disposed a number of arcuate Lee shaped elements 28 which are designed and configured to work in connection with the arcuately shaped grooves or slots 24 on the first component 14a to allow the first component to be adjusted outwardly in spaced relationship to the second component facilitating the use of the adjustable cable slitter 10 on larger cables. By turning the second component 14b in a predetermined manner and a predetermined amount, the arcuately shaped elements 28 disengage from the slots 24 in the first component 14a allowing the first and second components 14a, 14b to be separated and disengaged completely from one another as shown in FIG. 2.

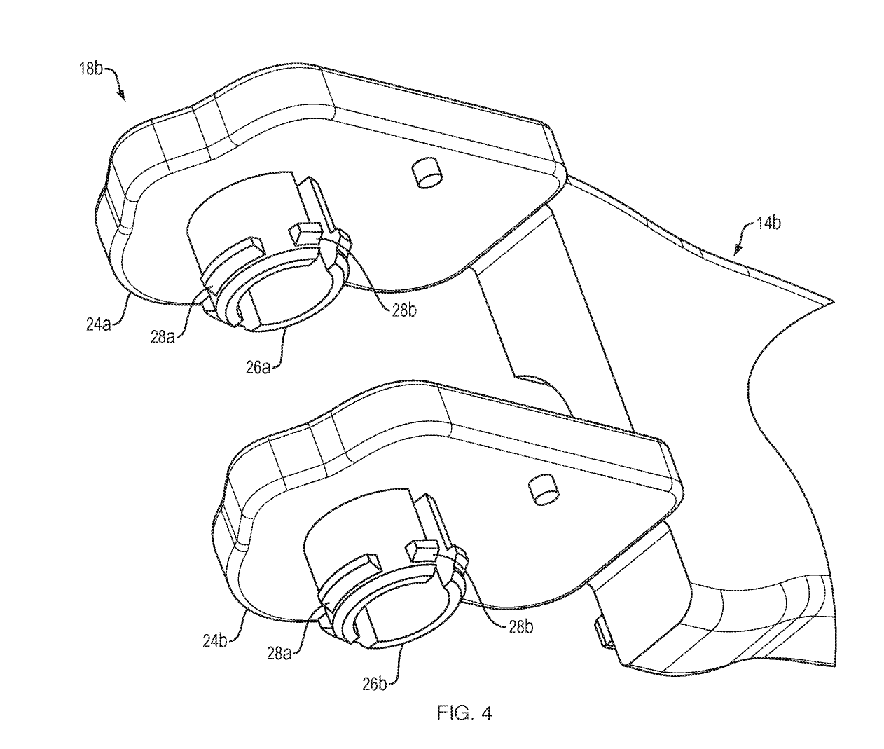

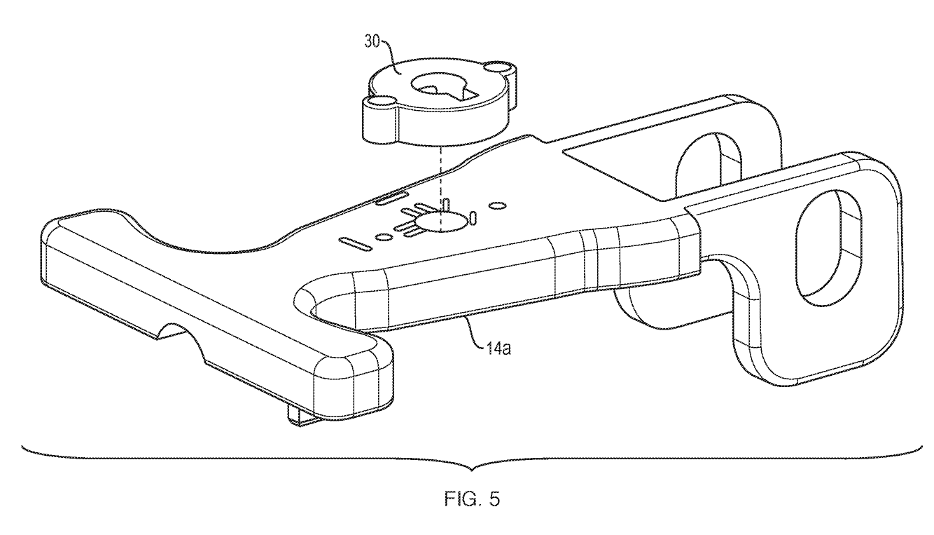

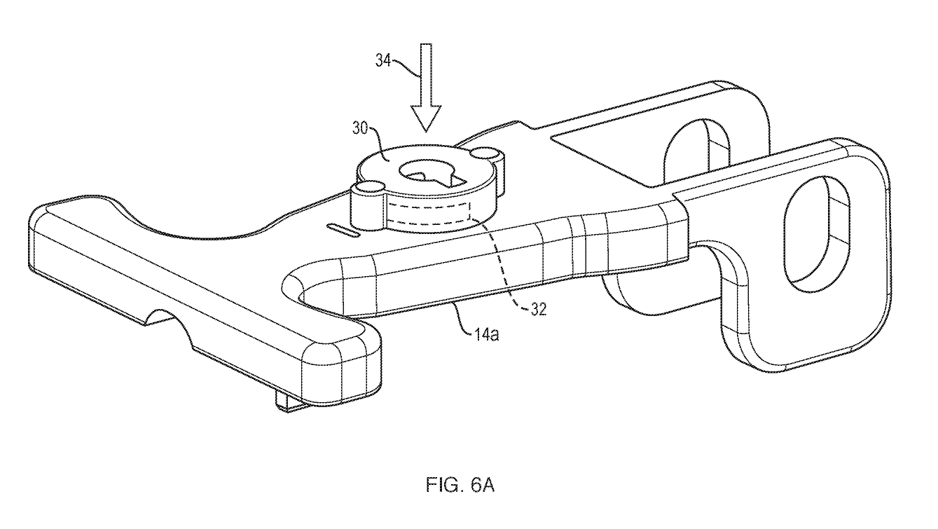

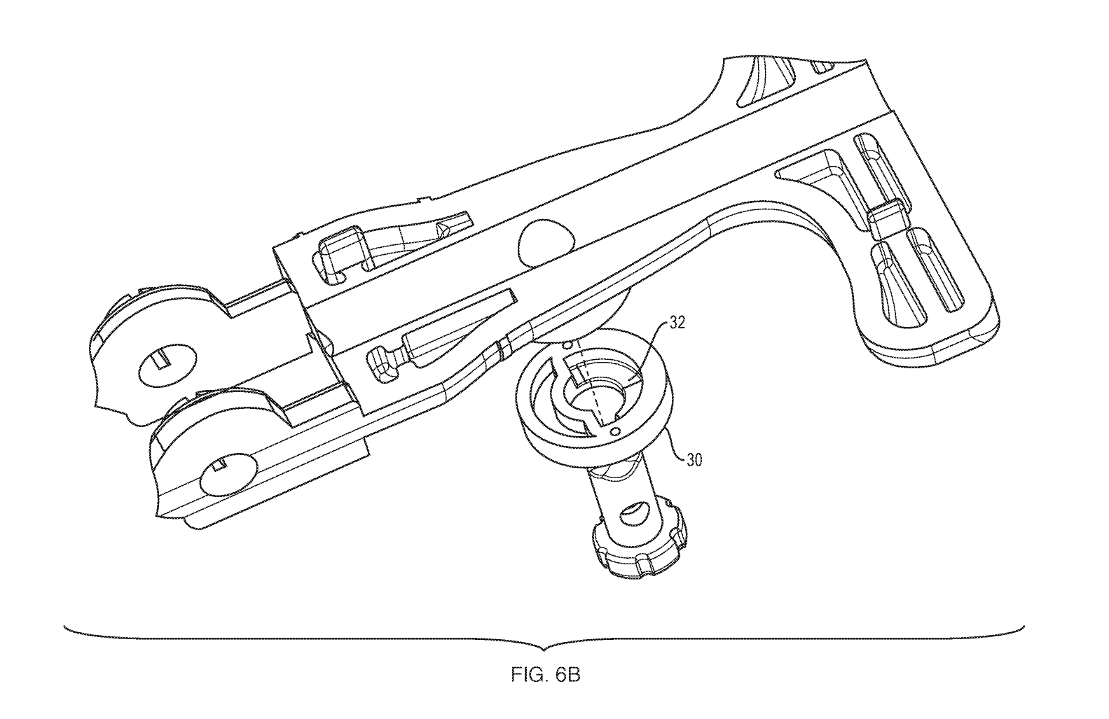

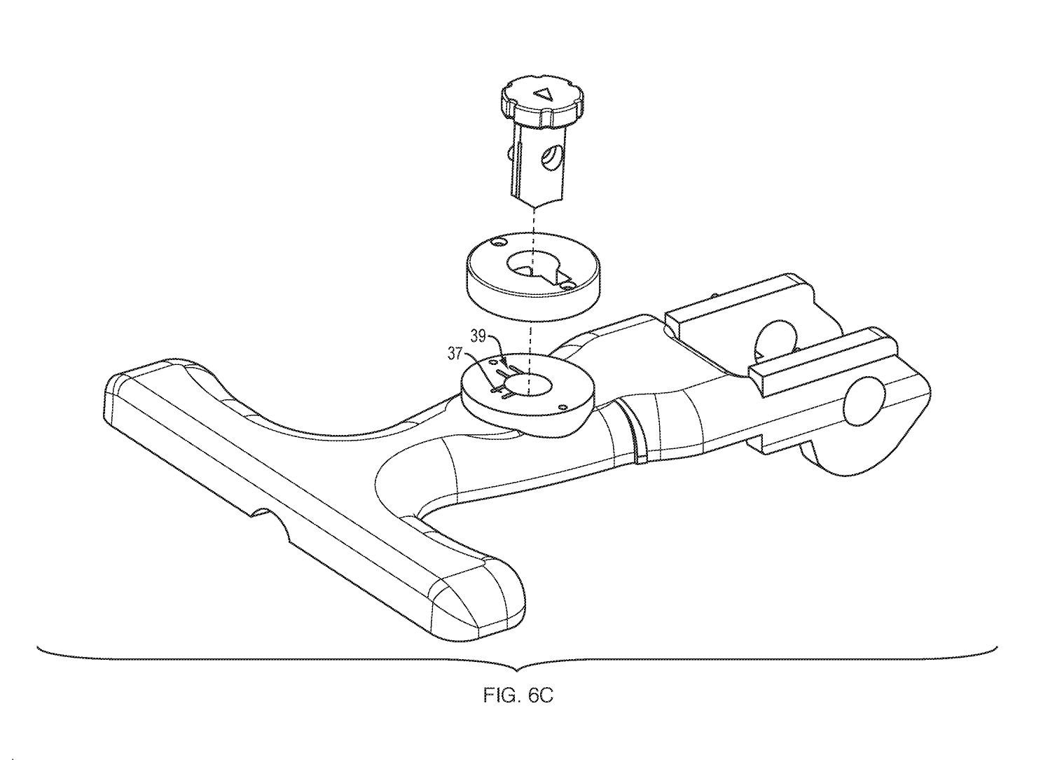

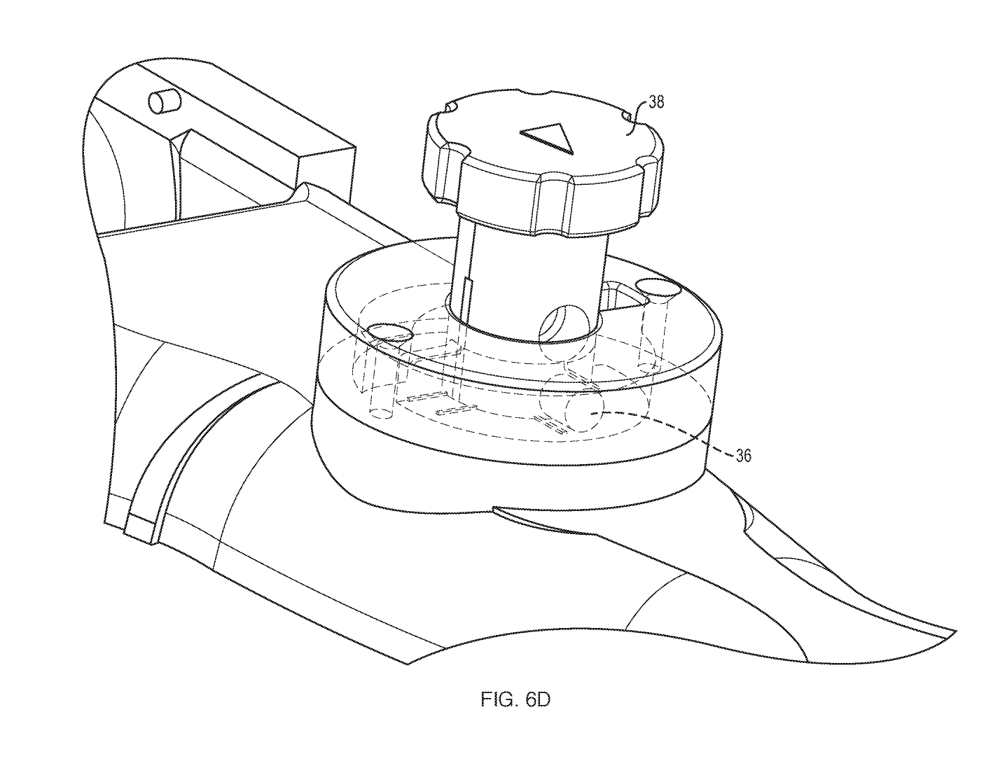

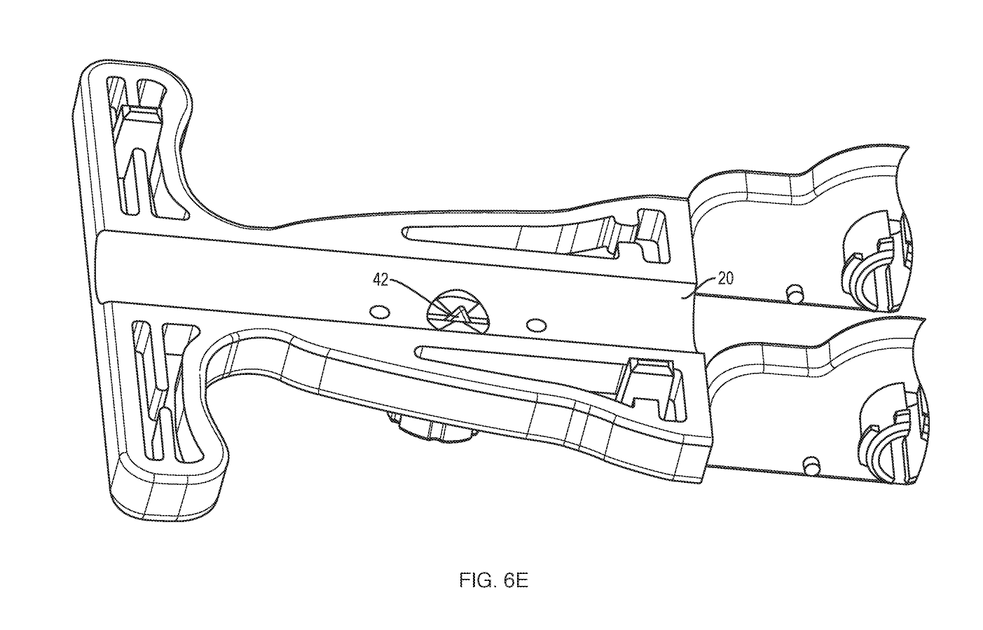

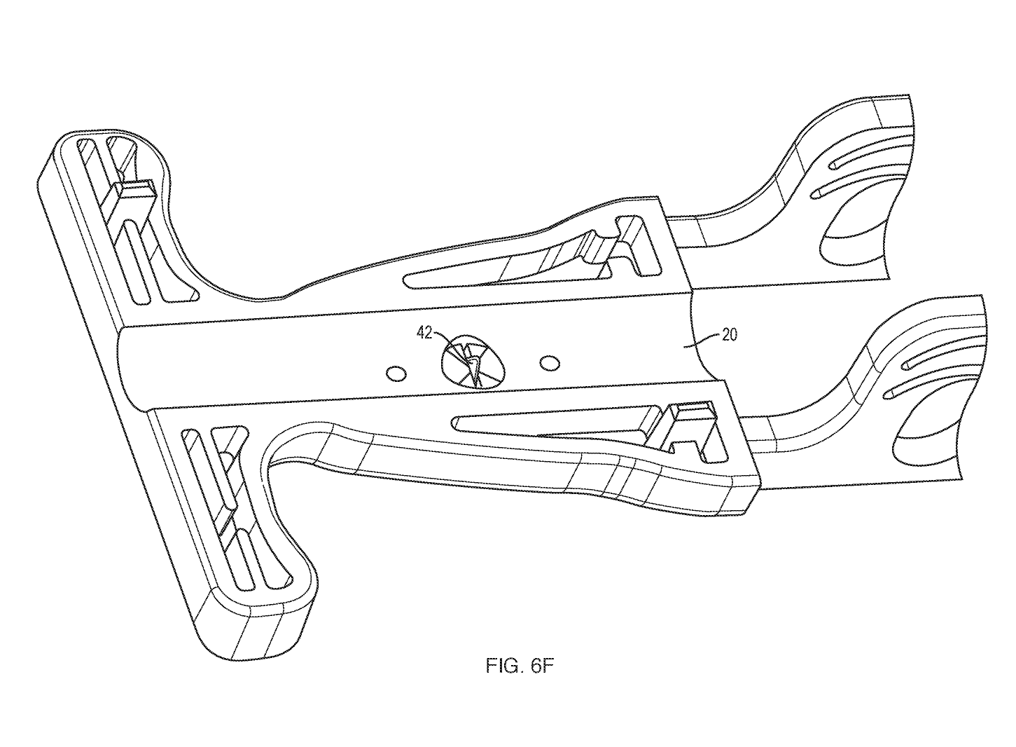

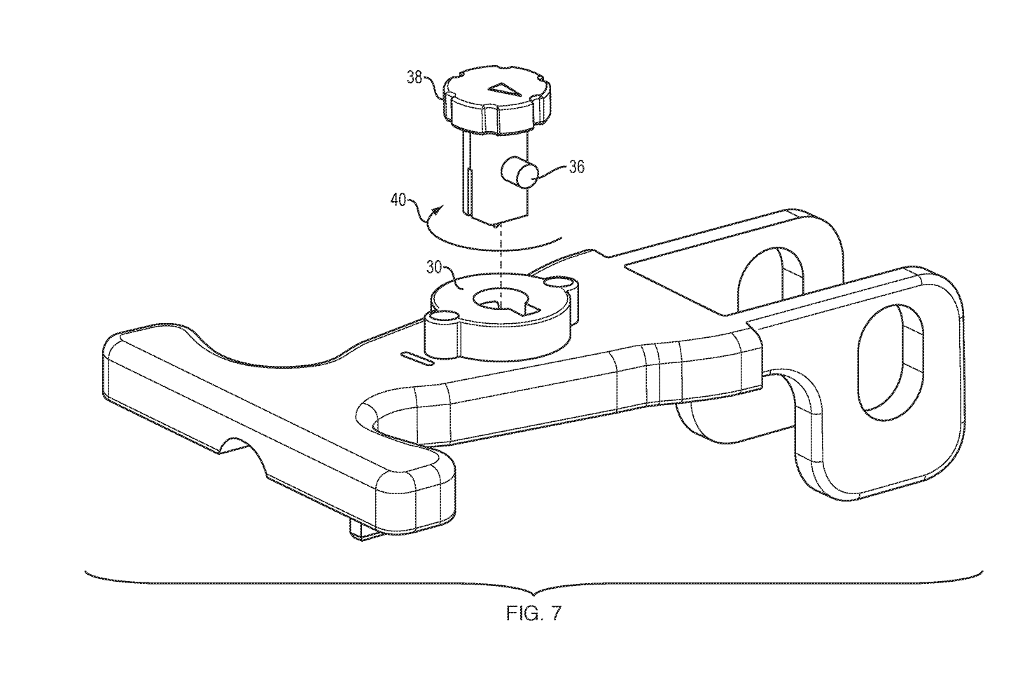

One or both of the first or second components 14a, 14b may be equipped with a knife or cutter which is utilized to slice or cut into the sheath or jacket of the cable. In the preferred embodiment, the knife or cutter is mounted into a knife or cutter mounting element 30, FIG. 5 which is mounted to the first or second member 14 as shown in FIG. 6. The knife or cutter mounting element 30 includes, on its interior surface, a groove or slot 32 shown in dashed lines in FIG. 6 and more clearly in FIG. 6A which begins proximate one side of the mounting element 30 and extends approximately 180° to the opposite side illustrated by arrow 34 in the mounting element 30. The slot 32 is configured to engage with a protrusion 36, FIG. 7 on the knife or cutter holder 38 and allow the knife or cutter holder 38 to be rotated 180° as shown by arrow 40 thereby aligning the cutter or knife 42, FIG. 11, to be rotated from a first position whereby the adjustable cable slitter 10 may be rotated 360° around the cable thereby cutting the sheath or jacket circumferentially around the cable or alternatively, the knife or cutter holder 38 may be rotated 90° and the adjustable cable slitter 10 placed around a cable and drawn or pulled along the length of the cable to cut or slice the cable jacket or sheathing along the middle of the cable to allow a technician to splice or repair the interior wires are filaments in the interior of the cable.

The knife mounting element 30 includes 2 sets of raised ribs 37, 39, FIG. 6B, which serve as a resting spot for the protrusion 36 on the knife or cutter holder 38, FIG. 6C, working to ensure that the knife or cutter holder 38 stays in position between one or the other of the parallel pairs of ribs 37, 39.

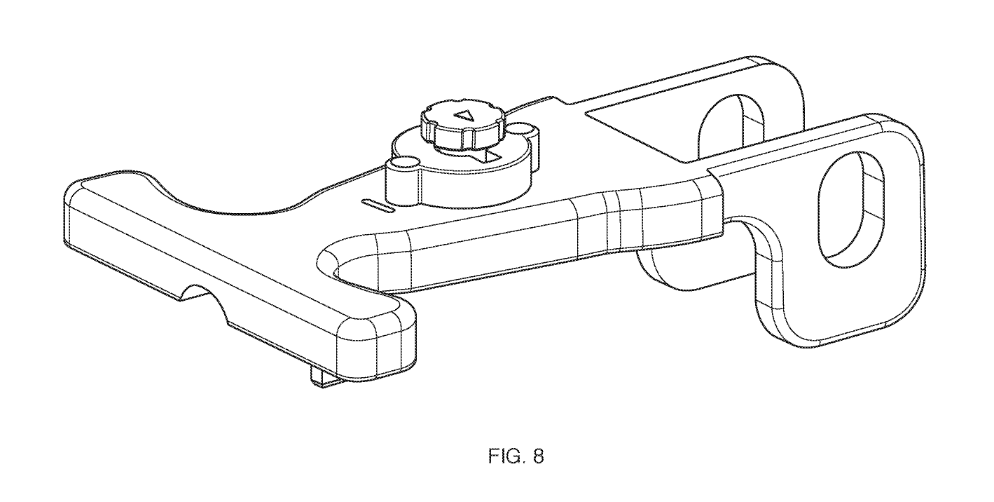

Once the knife or blade holder 38 is inserted into the knife or blade mounting element 30, as shown in FIG. 8, the blade tip 42 protrudes a predetermined amount within the channel 20 in the body portion 14 of the adjustable cable slitter 10, FIGS. 6D and 6E, according to a first embodiment of the present invention. The blade tip 26 protruding into the channel only goes a predetermined amount or distance into the channel, but does not protrude beyond the top surface of the channel. As a result, the protruding blade tip 42 is contained completely within the channel 20 and cannot cut someone who runs his or her fingertip along the top surface of the body portion 14.

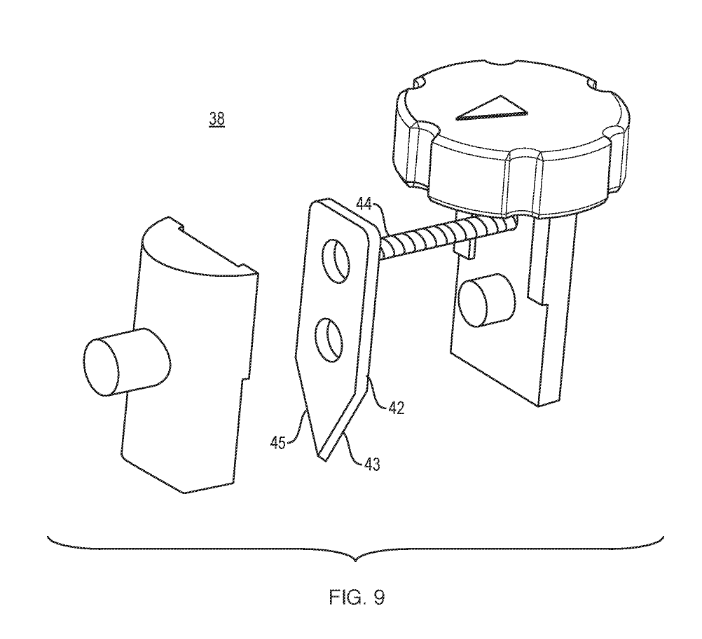

The blade or cutter or knife housing or holder 38 is constructed as a removable portion of blade mounting element 30. The blade housing 38 is sized and shaped to accommodate a blade 42, FIG. 9. The blade is preferably an “arrow” shaped blade having two cutting edges 43, 45, or any other suitable blade.

In a first embodiment, a screw 44 passes through the utility blade from a first portion of the blade housing 38 into a corresponding threaded region in a second portion of the blade housing 38. Once the blade 42 is inserted and the removable portion of the blade housing 38 is inserted into the blade mounting element 30, the blade 30 will be held such that only a portion of the blade tip 42 will protrude through the channel 20 (as shown in FIG. 11). In this aspect of the invention, the blade housing has a fixed blade.

The adjustable cable slitter illustrated in FIGS. 1-12 is designed to slit the top (and/or bottom) region of a circular cable or circumferentially around the circumference of a circular cable.

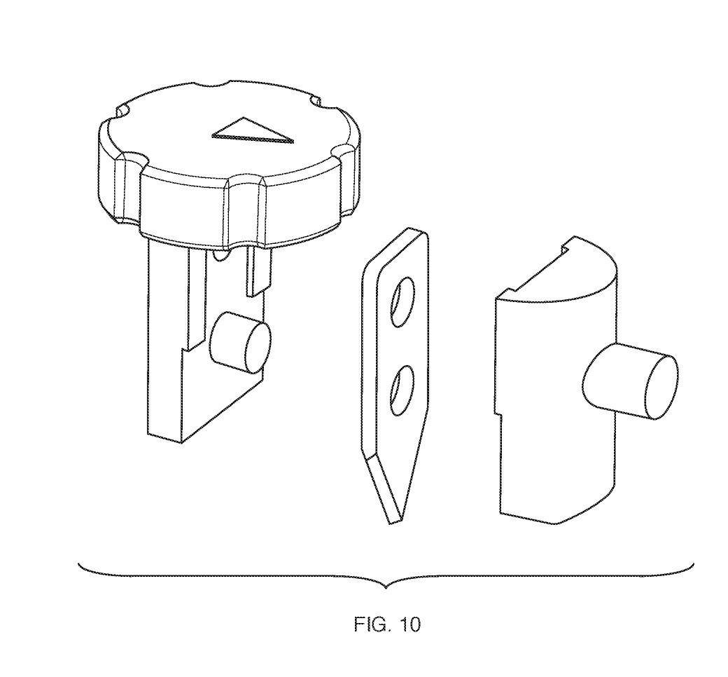

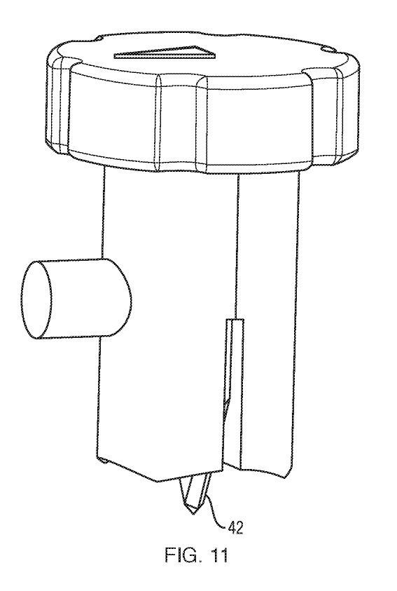

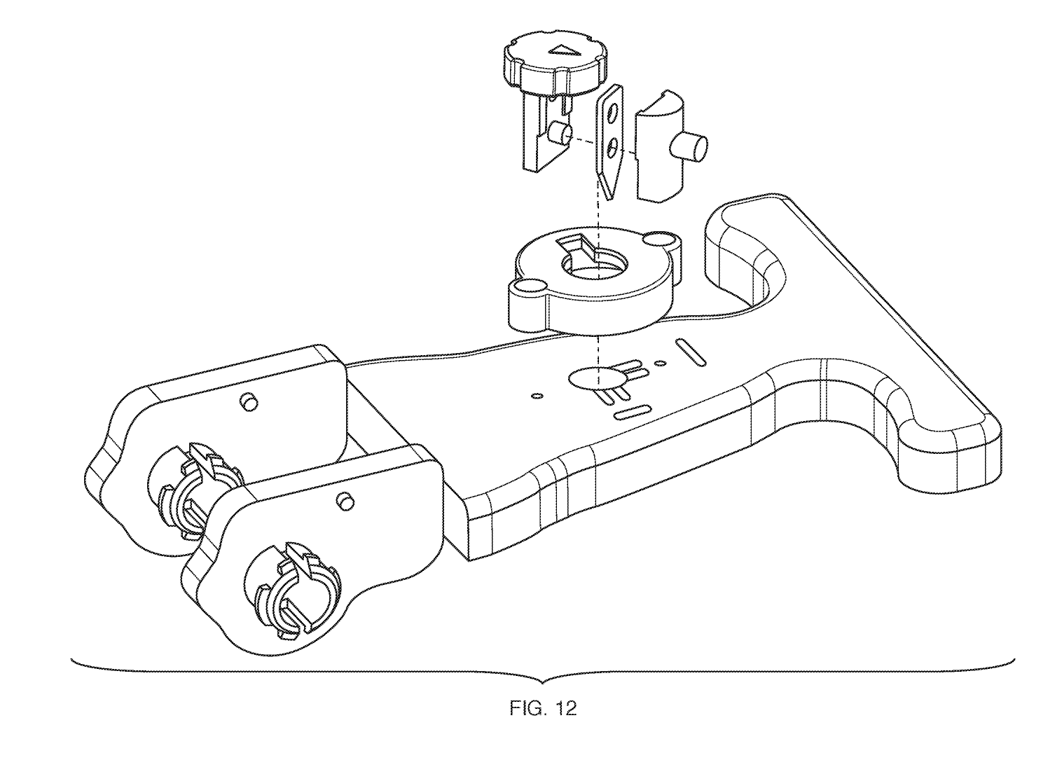

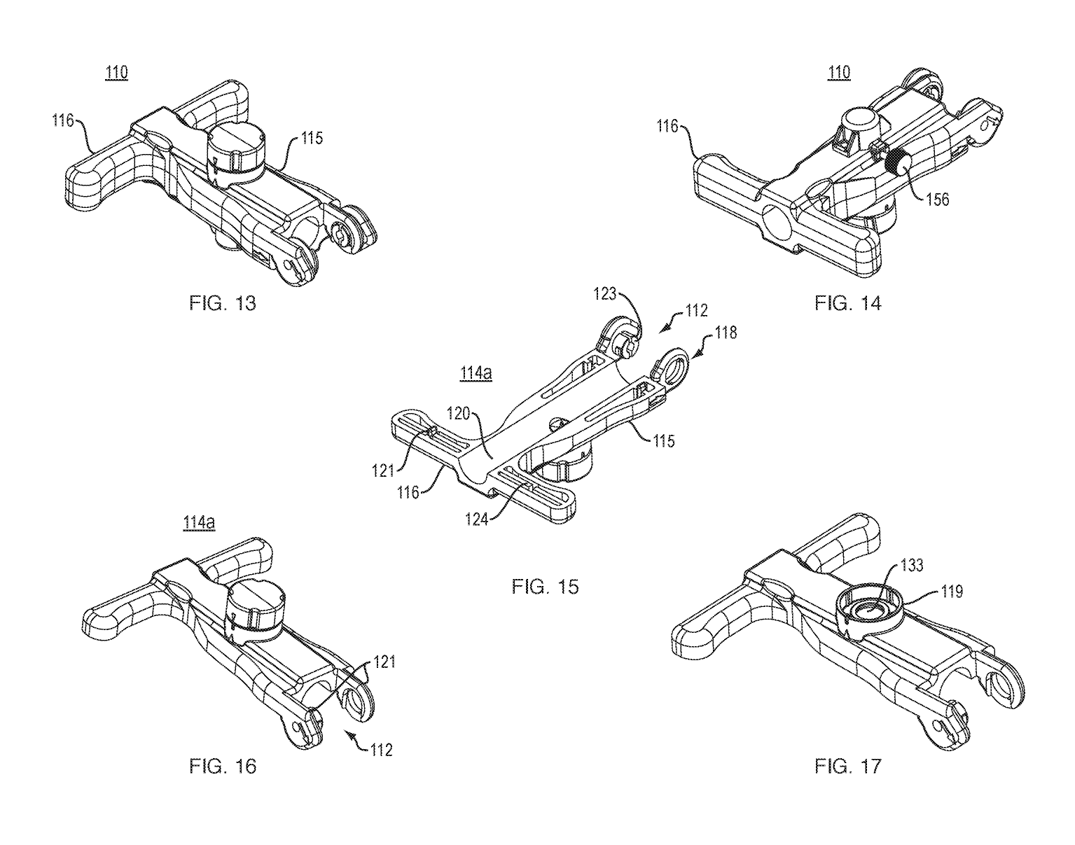

The adjustable cable slitter 110, FIG. 13, in accordance with the second and preferred embodiment of the present invention includes a hinge portion 12 a body portion 14 and a T-shaped handle portion 16. The adjustable cable slitter 10 is preferably made from a relatively strong, weatherproof, durable material such as plastic, aluminum or composite material. The plastic material is preferably a smooth, high slip material that is self-lubricating, such as an acetyl polymer, which may be purchased from Celanese Corporation, or another suitable plastic material. This type of generally “slippery” plastic material facilitates sliding the adjustable cable slitter along the length of a cable to be slit.

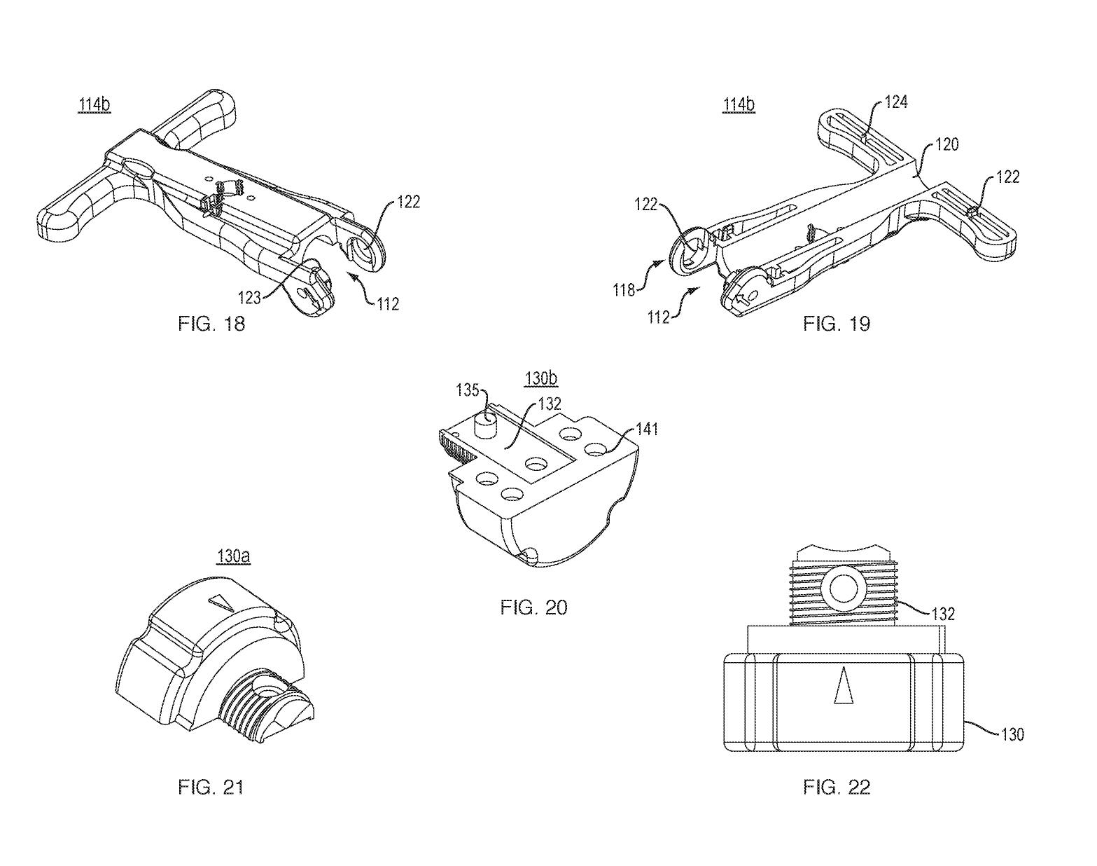

The adjustable cable slitter 110 in accordance with the second embodiment of the present invention and shown in perspective in FIGS. 13 and 14 includes a first or top component 114A (a top view of which is shown in FIGS. 16 and 17 and a bottom view of which is shown in FIG. 15) and a second or bottom component 114B (a top view of which is shown in FIG. 18 and a bottom view of which is shown in FIG. 19). The first and second components each include a groove or channel 120 into which the cable will fit. The first and second components 114 typically contain one channel or groove 120 although this is not a limitation of the present invention as the adjustable cable slitter 110 may be configured with multiple channels or grooves 120. The cable to be slit can be a fiber optic cable, a copper cable, or any other type of cable.

Each of the first and second components 114 includes a hinge portion The hinge portion 112 constructed and arranged such that the first component 114a is separable from the second component 114b allowing the adjustable cable slitter 110 to be placed over and around a cable at any point along the cable either in the middle of the cable or at the end of a cable. The first component 114a and the second component 114b can rotate from an open position to a closed position. In a closed position, the protrusions 122 on the T-shaped handle 116 of the first and second components 114, will, if provided, insert into corresponding holes or slots 124 of the other component.

The adjustable ends 118 of both the first and second components 114 include first and second parallel flanges 121 one of which includes a circular shaped opening 122 on one portion of the adjustable end 118 as well as a second portion 123 including one or more arcuately shaped and or circular protrusions which are designed to mate with a corresponding opening in the mating portion 122. By turning the one component 114a/114b vis-à-vis the other component in a predetermined manner and a predetermined amount, the arcuately shaped elements disengage from the slots and openings allowing the first and second components 114a, 114b to be separated and disengaged completely from one another.

The hinge portion 112 allows the body portion 115 to come apart into two pieces allowing, in one embodiment, the adjustable cable slitter 10 to be placed Midway at any point along a given length of cable to allow the cable jacket or sheath to be slit and a splice or other interconnection made along the middle of the cable. Alternatively, the adjustable cable slitter 110 may be inserted over the end of the cable without disconnecting or disengaging the two body portions 115.

The T-shaped handle portion 116 is arranged perpendicular to the body portion 115. The body portion 115 of the first or top portion 114a further includes a blade housing 118 that holds and encloses a blade 42 and is shown in FIGS. 20 through 22. The blade 42 can be a knife blade, a utility knife blade, a mini blade, or any other suitable blade 42 as shown in FIGS. 9, 10 and 11. The blade 42 is used to penetrate the cable jacket or sheath (not shown) without cutting the underlying cable wires or filaments. The penetration can be in the form of a cut or slice, or any other means which provides access to the interior region of the cable and the one or more cable wires or filaments contained within the cable jacket or sheath.

In the preferred construction of the second embodiment of the invention, the knife or cutter 42 is mounted into a two-part knife or cutter mounting element 130, FIGS. 20-23, which is mounted to the first member 114a by means of a cutter mounting element base 119, FIG. 17. The cutter mounting element 130 includes, proximate one end, a threaded protrusion 132, FIG. 22 which engages with a mating threaded female region or opening 133 FIG. 17 in the top or first body portion 114. The knife or cutter mounting element 130 includes, on its interior surface, a groove or slot 132 shown in FIGS. 20 and 23, as well as protrusions 135 which allow the mating portions 130a and 130b to come together and also serve to capture the blade 42 in place given corresponding holes in the blade 42.

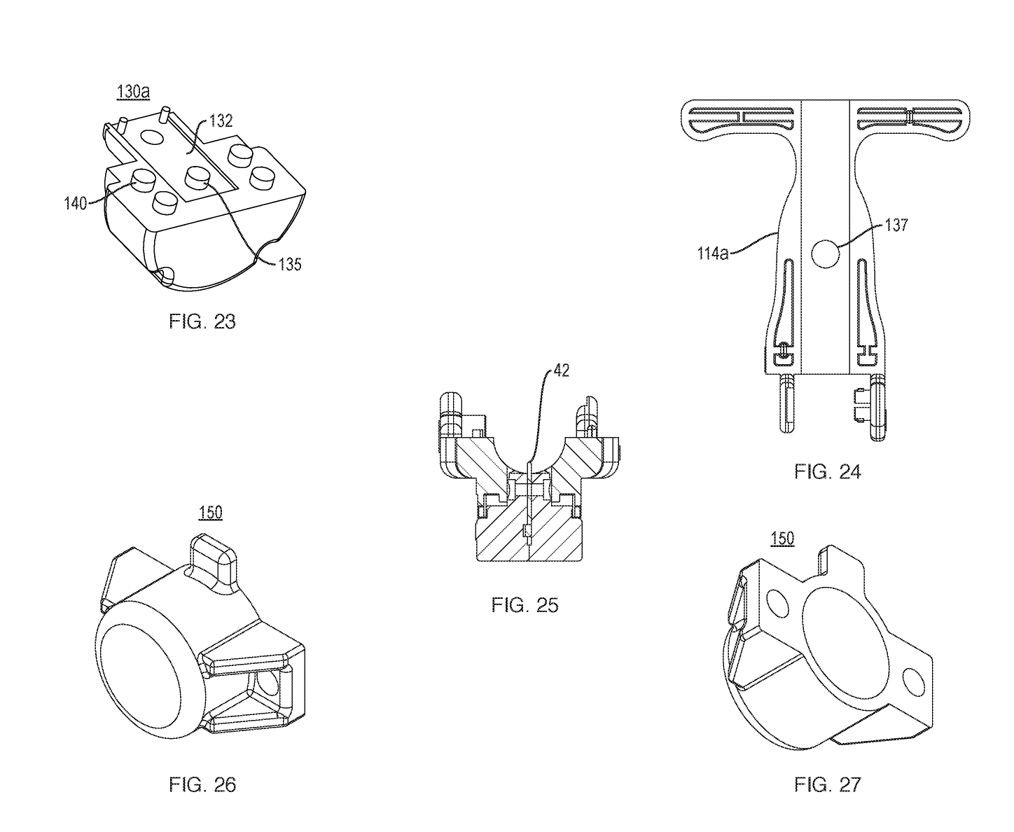

The knife mounting element 130 includes a threaded protrusion 132, FIG. 22 which is designed to mate with a threaded opening 137 FIG. 24 in the top body portion 114a. The knife mounting element protrusion 132 is screwed into the threaded opening 137 and comes to rest in the knife holder mounting element 119, FIG. 17. By turning the knife mounting element 130 clockwise or counterclockwise, the “depth” or amount of the knife blade tip can be adjusted to protrude more or less into the channel 120 as shown in FIG. 25. In addition, the knife mounting element 130 can be adjusted such that the knife tip is parallel to the channel 120 or perpendicular to the channel 120 if it is desired to cut a circumferential slot in the cable.

Once the knife or blade 42 is inserted into the knife or blade mounting element 130, the blade tip protrudes a predetermined amount within the channel 120 in the body portion 114 of the adjustable cable slitter 110 as shown in FIG. 25. The blade tip protruding into the channel 120 only goes a predetermined amount or distance into the channel, but does not protrude beyond the top surface of the channel. As a result, the protruding blade tip 42 is contained completely within the channel 20 and cannot cut someone who runs his or her fingertip along the top surface of the body portion 14.

The blade or cutter or knife housing or holder 130 is constructed as a two piece removable portion of blade mounting element 130a and 130b. The blade mounting element 130a and 130b is sized and shaped to accommodate a blade 42, FIG. 9. The blade is preferably an “arrow” shaped blade having two cutting edges 43, 45, or any other suitable blade.

In a first embodiment, the two portions 130a and 130b of the blade mounting element snapped together utilizing a number of protrusions 140 which made with correspondingly positioned and sized openings 141 in the mating portion. Once the blade 42 is inserted into the blade mounting element 130, the blade 42 will be held such that only a portion of the blade tip 42 will protrude through the channel 120 (as shown in FIG. 25). In this aspect of the invention, the blade housing has a fixed blade.

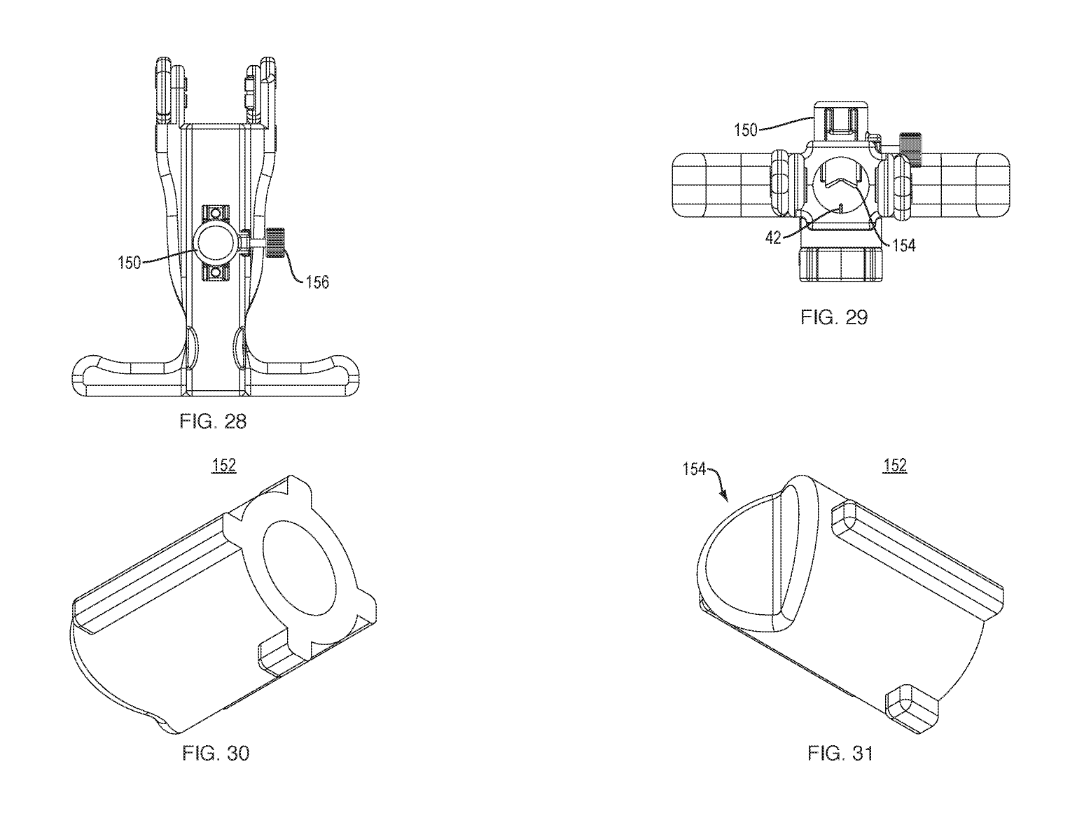

Another feature of the second and preferred embodiment of the present invention is the provision of a spring cap 150, FIGS. 26 and 27. The spring cap is mounted to the bottom portion 114b as shown in FIGS. 28 and 29. The spring cap 150 is designed to receive a pressure plate element 152, FIGS. 30 and 31. The purpose of the pressure plate element 152 is to provide a v. shaped region 154 which is designed to be adjustable to the positioned in the channel 120 so as to exert a proper amount of pressure against the cable to be slit. This arrangement is shown in FIG. 29. The adjustability of the pressure plate 152 allows of the present invention to be utilized with different size cables and to ensure that the cable makes full and complete contacts with that portion of the channel 120 into which protrudes the knife or cutter blade or point 42. The pressure plate 152 engages with the spring cap 150 and is adjustable while at the same time being held in position at the proper height as adjusted by the user utilizing a bolt with a neural For example 156, FIG. 28 in FIG. 14 which is inserted into a threaded hole in the bottom body portion 114b.

Accordingly, the adjustable cable slitter as illustrated and described in connection with the two disclosed embodiments is designed to slit the top (and/or bottom) region of a circular cable longitudinally or circumferentially around the circumference of the circular cable.

The present invention is not to be limited by any preferred or exemplary embodiments or features disclosed herein. Modifications and substitutions by one of ordinary skill in the art are considered to be within the scope of the present invention, which is not to be limited except by the allowed claims and their legal equivalents.

1. A device for cutting an exterior layer of a cable, the device comprising:
a first component and a second component, each of the first and second components having a main body portion having a length, an exterior side, an interior side, a first end and a second end opposite the first end;
each of the first and second components including a channel that runs along the entire length of the interior side of the first and second components;
wherein the first end of the main body portion of each of the first and second components has a T-shaped handle and wherein the second end of the main body portion of the first component is designed to releasably, rotatably and expandably interconnect with the second end of the main body portion of the second component, and wherein the first and second rotatably interconnected components are configured for receiving a cable in the channel in the interior side of the first and second components; and
at least one blade housing, located on the exterior side of at least one of the first and second components within the main body portion, the at least one blade housing configured for securely, rotatably and removably holding at least one knife blade in a position such that at least a portion of the at least one knife blade protrudes into the channel in the interior side of the at least one of the first and second components and at least partially into the channel of the at least one of the first and second components on which the knife blade is located, and wherein said blade housing includes a blade holder portion and a blade holder mounting portion, wherein the blade holder portion and the blade holder mounting portion are configured to cooperate to allow the blade holder portion and the blade to rotate at least 90° within the channel of the first and second components.

2. The device of claim 1, wherein the first and second components are configured for being disconnected from one another whereby the cable to have its exterior layer cut is inserted into the device and wherein the first and second components are configured for being rotatably connected and brought into a closed, confronting position whereby the interior portion of the first component contacts the interior portion of the second component, the device further configured to cut the exterior layer of the cable when the first and second components in the closed position are advanced along a length of the cable.

3. The device of claim 1, wherein the first and second components are made from a plastic material.

4. The device of claim 3, wherein the plastic material is manufactured to be a “slippery” plastic material such as PTFE.

5. The device of claim 1, wherein the second end of each of the first and second components further comprises:
a first hingeable interconnection member having a circular portion that contains one or more notched depressed areas in a central region of the circular portion; and
a second hingeable interconnection member disposed in a spaced relationship with the first hingeable interconnection member and having one or more notched raised areas, wherein the one or more notched raised areas on the second hingeable interconnection member of the first and second components are configured to be inserted into or removed from the one or more notched depressed areas of the first hingeable interconnection member of the other of the first and second components.

6. The device of claim 5, wherein the first and second components each further include a first arrow on a first side of the second end of the main body portion proximate the first hingeable interconnection member, and a second arrow on a second side of the second end of the main body portion proximate the second hingeable interconnection member, the arrows configured for providing a visual indication of a position of the first and second components, wherein the first hingeable interconnection member and the second hingeable interconnection member can attach or separate only when the first and second arrows align, thereby providing a visual indication of a position when the one or more notched raised areas on the second hingeable interconnection member of the first and second components are configured to be inserted into or removed from the one or more notched depressed areas of the first hingeable interconnection member of the other of the first and second components.

7. The device of claim 1, wherein a path is formed by the channel of the first component and the channel of the second component when the first and second components are brought into a closed, confronting position against one another, and wherein the path that is formed has a circular shape designed to accept a circular cable.

8. The device of claim 1, wherein a path is formed by the channel of the first component and the channel of the second component when the first and second components are brought into a closed, confronting position against one another, and wherein the path that is formed has a round shape designed to accept a round, fiber optic cable.

9. The device of claim 1, wherein the at least one blade housing includes a first blade housing located on the exterior side of the first component and a second blade housing located on the exterior side of the second component.

10. The device of claim 1, wherein the channel in the second component further includes an opening that allows a portion of the exterior layer of the cable sliced by the at least one blade to exit the device.

11. A device for cutting or scoring the jacket or sheath of a cable, the device comprising:
a first component and a second component, each of the first and second components having a main body portion having a length, an exterior side, an interior side, a first end and a second end opposite the first end;
each of the first and second components including a semi-circular channel that runs along the entire length of the interior side of the first and second components;
wherein the first end of the main body portion of each of the first and second components has a T-shaped handle, and wherein the second end of the main body portion of each of the first and second components includes a coupling device, the coupling device configured for releasably, expandably and rotatably coupling the first and second components; and
a first blade housing, located on the exterior portion of the first component and a second blade housing, located on the exterior portion of the second component, for securely yet removably holding a blade and for allowing a predetermined amount of a tip portion of the blade to project into the channel of the at least one of the first and second components on which the knife blade is located.

12. The device of claim 11, wherein a path is formed by the channel of the first component and the channel of the second component when the first and second components are brought into a closed, confronting position against one another, and wherein the path that is formed has a semi-circular shape designed to accept a circular fiber optic cable.

13. The device of claim 11, wherein a path is formed by the channel of the first component and the channel of the second component when the first and second components are brought into a closed, confronting position against one another, and wherein the path that is formed has a round shape designed to accept a round, fiber optic cable.

14. The device of claim 11 wherein the coupling device on the second end of the main body portion of each of the first and second components further comprises:
a first hingeable interconnection member having a circular portion that contains one or more notched depressed areas in a central region of the circular portion; and
a second hingeable interconnection member disposed in a spaced relationship with the first hingeable interconnection member and having one or more notched raised areas, wherein the one or more notched raised areas on the second hingeable interconnection member of the first and second components are configured to be inserted into or removed from the one or more notched depressed areas of the first hingeable interconnection member of the other of the first and second components.

15. The device of claim 11 wherein the knife blade is an arrow shaped knife blade having two cutting surfaces.
